(19) United States
(12) Patent Application Publication
(10) Pub. No.: US 2005/0069608 A1
(43) Pub. Date: Mar. 31, 2005

(54) Calcium dietary supplement

(76) Inventor: Lewis Hendricks, Richboro, PA (US)

Correspondence Address: RHODIA INC., 259 Prospect Plains Road, Cranbury, NJ, 08512, US

(21) Appl. No.: 10/950,235

(22) Filed: Sep. 24, 2004

Related U.S. Application Data
(60) Provisional application No. 60/506,576, filed on Sep. 26, 2003.

(51) Int. Cl. A23K 1/175

(52) U.S. Cl. 426/74

(57) ABSTRACT

A calcium dietary supplement is provided in chewable dosage form and contains a mixture of a particulate calcium phosphate salt and a chewable candy base.

### FIELD OF THE INVENTION

This invention relates to dietary supplements, more particularly to calcium-containing dietary supplements.

### BACKGROUND OF THE INVENTION

Mineral and vitamin compositions are routinely used as dietary supplements, either as general nutritional supplements or as therapeutic preparations directed to treat specific medical problems.

Calcium is an important nutrient for growing children to help in bone formation and for adults to help prevent bone loss. Excessive bone loss may lead to a condition known as “osteoporosis”, in which decreased bone mass causes the bones to be more brittle and thus more susceptible to fracture. It is widely believed that a chronic shortage of dietary calcium is one factor leading to osteoporosis, see Osteoporosis, Cause, Treatment, Prevention, U.S. Dept. of Health and Human Services, Public Health Service National Institutes of Health, Maryland 1987. Calcium dietary supplements appear to be of value in helping to prevent osteoporosis.

More recent work indicates that ingesting supplemental amounts of other minerals, such as phosphorus, in addition to supplemental amounts of calcium appears to provide additional benefits, see for example, Shapiro, R. and Heaney, R. P., “Co-dependence of calcium and phosphorus for growth and bone development under conditions of varying deficiency”, Bone 2003 May; 32(5):532-40.

There is a continuing interest in providing improved calcium dietary supplements which contain other components, such as phosphorus, in addition to calcium in order to promote healthy bone growth and slow or prevent bone loss.

### SUMMARY OF THE INVENTION

The present invention is directed to a calcium dietary supplement in chewable dosage form, comprising a mixture of a particulate calcium phosphate salt and a chewable candy base.

### DETAILED DESCRIPTION OF INVENTION AND PREFERRED EMBODIMENTS

Suitable calcium phosphate salts include, for example, tricalcium phosphate, dicalcium phosphate dihydrate, anhydrous dicalcium phosphate, and monocalcium phosphate.

In one embodiment, the supplement composition of the present invention comprises from about 1.4 to about 2.1 pbw, more typically from about 1.5 to about 2.0 pbw, calcium per pbw phosphorus.

Optionally, the relative amounts of calcium and phosphorus in the dosage form can be adjusted within the desired ranges by, for example, adding calcium sources that contain a relatively lower amount of phosphorus than the above described calcium phosphorus salts or that do not contain significant amounts of phosphorus or of phosphorus sources contain a relatively lower amount of calcium than the above described calcium phosphorus salts or that do not contain significant amounts of calcium.

Suitable calcium sources that do not contain significant amounts of phosphorus include, for example, calcium chelates, such as for example, amino acid chelates, and calcium salts, such as, for example, calcium carbonate, calcium gluconate, calcium citrate, calcium citrate maleate.

Suitable phosphate sources that do not contain significant amounts of calcium include, for example, phosphate salts, sodium phosphate, and proteins, such as, for example, soy protein, whey protein.

Control of the particle size distribution of the particulate calcium phosphate salt component of the dietary calcium supplement of the present invention allows production of a calcium dietary supplement that typically exhibits more appealing organoleptic properties, such as, for example, being perceived as smoother and less gritty, when chewed.

In one embodiment, the particulate calcium phosphate salt component of the dietary calcium supplement of the present invention has a particle size distribution wherein greater than or equal to about 50 percent by weight (“wt %”), more typically greater than or equal to about 75 wt %, and even more typically greater than or equal to about 90 wt %, of the salt has a particle size of less than about 10 micrometers (μm).

In one embodiment, the particulate calcium phosphate salt component of the dietary calcium supplement of the present invention has a particle size distribution wherein less than or equal to about 10 wt %, more typically less than or equal to about 5 wt % and even more typically less than or equal to about 1 wt %, of the salt has a particle size of greater than about 20 μm.

The dietary supplement composition of the present invention further comprises a chewable candy base. Suitable chewable candy bases are well known in the art.

In one embodiment, the chewable candy base is a taffy candy base comprising a mixture of flavoring and cooked sugar. In one embodiment, a taffy base is made by heating sugar to a temperature of about 250-255° F., allowing the mixture to cool somewhat and then adding the flavoring.

In another embodiment, the chewable candy base is a caramel candy base comprising a mixture of flavoring and a cooked mixture of sugar and lipids. In one embodiment, a caramel base is made by heating a mixture of sugar and lipid to a temperature of about 240- 255° F., allowing the mixture to cool somewhat and then adding the flavoring.

Suitable sugars are known and include, for example, corn syrup, cane sugar, beet sugar, glucose. Suitable lipids are known and include butter, cream, condensed milk, and vegetable oils, such as partially hydrogenated soybean oil. Suitable flavorings are known and include natural flavors, such as vanilla extract, cocoa powder, natural chocolate flavor, and fruit concentrates, as well as artificial flavors, such as vanillin and artificial fruit flavors.

In one embodiment, the chewable candy base is a soft chewable candy base and comprises an effective amount of a softening agent such as, for example, glycerin, glyceryl monostearate, or a lipid component.

The candy base may, optionally, contain other ingredients generally recognized as safe for food additive use, including for example, starches, such as wheat flour and cornstarch, preservatives, such as butylated hydroxytoluene, and butylated hydroxyanisole, food grade emulsifiers such as lecithin, propylene and glycol esters, seasonings, such as table salt, and food grade colorants, such as color additives that are certified or certifiable by United States Food and Drug Administration (the “US FDA”) for food use, such as for example, FD&C Blue No. 1 (Brilliant Blue FCF), FD&C Blue No. 2 (Indigotine), FD&C Green No. 3 (Fast Green FCF), FD&C Red No.40 (Allura Red AC), FD&C Red No. (Erythrosine), FD&C Yellow No. 5 (Tartrazine), and FD&C Yellow No. 6 (Sunset Yellow), as well as color additives that are exempt from US FDA certification, such as for example, annatto extract, B-apo-8′-carotenal, beta-carotene, beet powder, canthaxanthin, caramel color, carrot oil, cochineal extract (carmine); cottonseed flour (toasted partially defatted, cooked); ferrous gluconate, fruit juice, grape color extract, grape skin extract (enocianina), paprika, paprika oleoresin, riboflavin, saffron, titanium dioxide, turmeric, turmeric oleoresin, and vegetable juice.

The soft chews of the present invention are made by combining calcium and phosphorus components, as well as any optional components, with the chewable candy base in the desired relative amounts, mixing the components according to known methods to produce a substantially homogeneous mixture and forming the resulting mixture into individual soft chews.

In one embodiment, the relative amounts of the ingredients and the size of the soft chews are selected to provide a dosage of from about 100 milligrams (“mg”) to about 1200 mg, more typically from about 500 mg to about 600 mg, calcium per individual soft chew and from about 100 mg to about 1000 mg, more typically from about 200 mg to about 400 mg, phosphorus per individual soft chew

The dietary calcium supplement of the present invention provides an easily portable and convenient source of supplemental calcium and phosphorus.

### EXAMPLES 1 AND 2

The soft chews of Example 1 were made by mixing tricalcium phosphate having the following particle size distribution:

| Particle Size (μm) | wt % |
|---|---|
| <19.6 | 99 |
| <12 | 90 |
| <3 | 50 |
| <1.2 | 10 |

with a chewable chocolate caramel candy base, in the amount of about 21.9 pbw tricalcium phosphate per 100 pbw of chewable caramel candy base and forming the mixture into truncated cubes each about 6 grams (“g”) and having dimensions of about 0.8 inch×0.7 inch by 04 inch. The soft chews of Example 1 nominally contained 500 mg calcium and 260 mg phosphorus per chew.

The soft chews of Example 2 were made according to the procedure describe in Example 1 above, except that tricalcium phosphate having the following particle size distribution:

| Particle Size (μm) | wt % |
|---|---|
| <100 | 99 |
| <45 | 95 |
| <20 | 50 |
| <2 | 10 |

was used.

In a blind tasting, the soft chews of Example 1 are perceived as being less chalky, less crunchy, less gritty and smoother than those of Example 2.

1. A calcium dietary supplement in chewable dosage form, comprising a mixture of a particulate calcium phosphate salt and a chewable candy base.

2. The supplement of claim 1, wherein the calcium phosphate salts comprises one or more of tricalcium phosphate, dicalcium phosphate dihydrate, anhydrous dicalcium phosphate, and monocalcium phosphate.

3. The supplement of claim 1, wherein the supplement comprises from about 1.4 to about 2.1 pbw, more typically from about 1.5 to about 2.0 pbw, calcium per pbw phosphorus.

4. The supplement of claim 1, wherein greater than or equal to about 50 percent by weight of the particulate calcium phosphate salt has a particle size of less than about 10 micrometers.

5. The supplement of claim 1, wherein greater than or equal to about 75 percent by weight of the particulate calcium phosphate salt has a particle size of less than about 10 micrometers.

6. The supplement of claim 1, wherein greater than or equal to about 90 percent by weight of the particulate calcium phosphate salt has a particle size of less than about 10 micrometers.

7. The supplement of claim 1, wherein less than or equal to about 10 percent by weight of the particulate calcium phosphate salt has a particle size of greater than about 20 micrometers.

8. The supplement of claim 1, wherein less than or equal to about 5 percent by weight of the particulate calcium phosphate salt has a particle size of greater than about 20 micrometers.

9. The supplement of claim 1, wherein less than or equal to about 1 percent by weight of the particulate calcium phosphate salt has a particle size of greater than about 20 micrometers.

9. The supplement of claim 1, wherein the chewable candy base is a taffy candy base comprising a mixture of flavoring and cooked sugar.

10. The supplement of claim 1, wherein the chewable candy base is a caramel candy base comprising a mixture of flavoring and a cooked mixture of sugar and lipids.

11. The supplement of claim 1, wherein the supplement comprises from about 100 milligrams to about 1200 milligrams calcium per individual soft chew and from about 100 milligrams to about 1000 milligrams phosphorus per individual soft chew.
